(19) United States
(12) Patent Application Publication
(10) Pub. No.: US 2009/0282615 A1
(43) Pub. Date: Nov. 19, 2009

(54) DEVICE FOR FURNITURE

(76) Inventor: Jon Olav Prosch, Roros (NO)

Correspondence Address: DENNISON, SCHULTZ & MACDONALD, 1727 KING STREET, SUITE 105, ALEXANDRIA, VA, 22314, US

(21) Appl. No.: 12/298,775

(22) PCT Filed: May 4, 2007
(86) PCT No.: PCT/NO07/00158

§ 371 Date: Apr. 24, 2009

(30) Foreign Application Priority Data
May 10, 2006 (NO) 20062096

(51) Int. Cl. A47C 19/02; F16C 11/10; A47B 96/00

(52) U.S. Cl. 5/607; 403/24

(57) ABSTRACT

Device for furniture, preferably to provide better access to the area under the furniture, for example in relation to cleaning, which furniture includes an upper part (20, 120, 131) and a lower part (30, 126, 134), and the upper part (20, 120, 131) can be tilted about a longitudinal rotation axis, between a substantially horizontal position and a vertical position. The device preferably includes a centrally/middle arranged tube axis (40, 122) which directly or indirectly connects the upper part (20) to the lower part 30, and in which tube axis 40 and/or at suitable peripheral places of the tube axis (40, 122), a manual and/or automatic lock mechanism is arranged.

The invention relates to a device for furniture, specially a lock and tilt mechanism according to claim 1, where the upper part of the furniture can be tilted about a longitudinal axis of rotation to preferably obtain better access to the floor area beneath.

### BACKGROUND

Furniture, especially double-beds and base beds, have such short legs that the distance from the bottom of the bed/bed base to the floor makes it difficult for a cleaner to clean by washing, mopping or vacuuming. While cleaning, the cleaner must stand bent or bend down on his/her knees to clean under a bed. Traditional beds are as known stationary and without possibilities for moving, unless the legs are provided with wheels. Even though the bed is provided with wheels, the interior design of a room often does not allow a bed to be moved, and especially not a double-bed. It is therefore desirable to design a bed that facilitates the access of the floor area under the bed, such that cleaning can be performed in an ergonomically favourable way, where the cleaner is able to clean the entire floor area under the bed from a standing working position. This can be achieved by providing the bed with a tiltable upper part in relation to the lower part.

Known solutions of beds with tiltable functions, are especially hospital beds, where bedridden persons often get problems in the circulation system in some parts of the body where the weight presses against the bed bottom or against support arranged on the bed bottom, e.g. a mattress. This is particularly problematic for unconscious patients, patients who are in a coma or physically disabled persons, etc., and often results in discomfort and bedsores. To prevent such problems from developing, bedfast patients can be turned regularly, e.g. every hour such that the patient lies in different positions and thus avoids pressure form contact with the bed bottom. Such solutions are often complicated and motorized.

NO 308768 relates to a device for a bed, particularly for handling e.g. hospitalized bedridden patients, for example when the patient's position needs to be changed, the bed to be made, or examinations to be carried out. The bed bottom is arranged to be shifted between an essentially horizontal position and two laterally pivoted positions, in which the bed bottom in the area of a lower longitudinal side is angled for the purpose of forming a lateral contact area.

DE 4039907 shows a bed which is mounted on a frame and which can be rotated relative to the frame about a longitudinal axis which passes through the centre of gravity of the patient's body.

None of the above mentioned solutions are designed to provide better access to the floor area under the furniture. The known solutions are in addition complicated, motorized and expensive as regards design. The known solutions are not designed for use in for example a hotel room or in the ordinary home.

### OBJECT

A object of the invention is thus to provide a device for a furniture, preferably a bed, which is plain, of moderate cost and secure and which solves the above mentioned problem with providing access to the floor area under the bed/furniture, according to claim 1.

Another object of the invention is to provide a suitable pivot/tilt mechanism which can be used for different types of furniture, to lock the constructions in different positions and/or provide a tilt movement. Among other things the mechanism can be utilized on tables, couches and chairs/benches designed for private or public rooms, and in vehicles and vessels for transport of personnel, and provide such furniture constructions with preferable properties.

### THE INVENTION

The invention is described in claim 1. Further details of the invention are described in claims 2-21.

To provide a device such that an article of furniture, e.g. a bed, is to be provided with the property that access to the floor area under the furniture is provided, a tilt mechanism is arranged around a middle/centrally arranged tube axis in the longitudinal direction of the furniture.

The furniture preferably includes a construction that includes an upper and a lower part, where the upper part is supported by the lower part (e.g. legs or headboards and footboards, and other similar lower parts) by means of a centrally/middle arranged tube axis, which directly or indirectly connects the upper part to the lower part. The shape is to consider as untraditional and relates to the furniture's unique function. The larger angle from the horizontal plane, the larger the distance from the floor to the furniture bottom gets.

To lock the upper part of the furniture in relation to the lower part of the furniture, a manually and/or automatic lock mechanism is arranged in the tube axis and/or at suitable peripheral/external positions of the tube axis.

The upper part of the construction (e.g. bed bottom, bed sides, mattress/base bed and similar frame constructions) can be tilted around the axially/middle arranged tube axis, which extends in the longitudinal direction of the furniture.

The invention will be illustrated in the form of examples of furniture, especially beds.

According to a first embodiment, a bed includes an upper part which is formed by a bed bottom with underlying transverse beams, which are firmly connected with each other. The lower part has preferably centrally arranged holes, through which holes the tube axis extends. The transverse curves and legs are further provided with recesses for locking means in adapted positions. Through the tube axis preferably extends an axle/bar with sleeves, which are provided with locking means. These locking means extend out through the milled longitudinal openings arranged in the tube axis. The upper part of the bed is locked and in stable position in relation to the lower part when the locking means are inserted in the transverse supporting beams on the lower part of the bed. The upper part of the bed will lock and stabilise to the lower part when these locking means are inserted in recesses in the transverse supporting beams.

In a manual lock mechanism for this embodiment, by pulling a handle (e.g. U-shaped) on a disk, which is arranged at the foot end of the bed, the axle with its sleeves and locking means will be pulled out, and the tilt mechanism is released.

To obtain a certain resistance when pulling out the axle, and so that the axle should spring back with a certain force of itself, when the bed is to be locked/stabilised, a spring is arranged in the axle at the head end of the bed, which spring for example is fixed in a suitable manner at the head end of the bed.

When the axle and the locking means are pulled out and the tilt mechanism is unlocked, the upper part can be pivoted/tilted in both directions about the tube axis, and better access to the floor area is obtained.

As the bed is to be set back, the upper part is tilted back to the initial position, i.e. horizontal position, and the handle is turned so that the lock mechanism falls back into locked position by means of the spring force.

Automatic propulsion and withdrawal of the axle by means of an automated/motorized lock mechanism can also be arranged, e.g. by means of an electric motor. The electric motor can be arranged preferably partly or entirely in the tube axis, e.g. at the head end, which motor has a drive shaft connected to a threaded bolt/screw. The inner wall of the tube axis is preferably further provided with threads and the threaded bolt/screw is adapted to these threads. In this way the threaded bolt/screw will screw the axle towards or away from itself, depending on the direction of rotation of the electric motor and thus pushing the locking means out of the mentioned recesses when the motor rotates in one direction, and pushing the locking means back when the motor rotates in the other direction.

Preferably different security means are arranged, such that the electrical motor can not start if the upper part is in a position where the locking means can be guided into the recesses.

Another way to provide an automatic lock mechanism is to adapt the sleeves on the axle/bar to the locking means. Thus the locking means instead of being fixed to the axle/bar, can be fixed to the tube axis and the locking means can for example be provided with springs to exhibit spring properties. The sleeves are as mentioned adapted to the locking means by us of an elliptic middle part. By rotating the axle with the sleeves inside the tube axis, e.g. by means of an electric motor, the elliptic middle part of the sleeves will result in the locking means being pressed down through the openings of the tube axis due to the spring forces, and the upper part is unlocked for pivoting/tilting. When the rotation of the axle is made the opposite way, the elliptic shape of the middle part of the sleeve will result in the locking means being pressed out again through the openings of the tube axis, and the upper part is again locked to the lower part. This embodiment can also off course be made manual, e.g. if means for rotating the axle is provided at the bed end.

Incidentally, any fully/semi-automatic device, which makes it possible to push the locking means according to the first embodiment, is to considered as a suitable driving source.

For beds with for example bed bases it is suitable that the mattress is arranged in the upper part, such that the mattress constitutes an active part of the bed's supporting upper part, e.g. by fixing the frame to transverse frame elements/beams in the upper part. Possibly, the bed base can in similar way as loose mattresses in beds entirely rest on a supporting frame construction, which can be arranged with a bed bottom. A supporting frame construction preferably includes at least two longitudinal frame elements and at least two transverse frame elements, which together form a preferably rectangular frame, to which frame a tube axis is arranged in a suitable way, which tube axis preferably is arranged centrally/in the middle. In one embodiment it further includes a thick-walled tube with a mounting bracket at one end. The thick-walled tube has an outer diameter which is adapted to the inner diameter of the tube axis, such that the thick-walled tube can be inserted into the tube axis and fixed in a suitable way. The mounting bracket of the thick-walled tube can either be fixed directly to the headboard or footboard, or to the upper part or the lower part of a bed. If the mounting bracket is fixed directly to the headboard or footboard, it will preferably be with peripheral/external lock mechanisms, i.e. peripheral in relation to the tube axis. A peripheral lock mechanism can be provided by arranging means for locking in the longitudinal frame elements, in each end of the longitudinal frame elements, for example in the form of locking pins. The headboard and footboard are further provided with locking holes, adapted to the locking pins. The locking pins can be pushed in and pulled out of these locking holes automatically, for example by means of electrical driving means. In this way the upper part, i.e. the frame construction, can be unlocked and locked, respectively, in relation to the lower part, i.e. the headboard and footboard. By use of a peripheral lock mechanism it is not necessary to use a thick-walled tube with a mounting bracket, but the tube axis can instead extend somewhat further than the frame construction and into holes arranged for this in the headboard and footboard, such that there is provided a rotation point for the tube axis and the frame construction in the holes.

In another embodiment, the tube axis and the thick-walled tube with a mounting bracket is used to provide an alternative lock mechanism, where the lock mechanism is arranged in relation to the thick-walled tube, where the thick-walled tube preferably is fixed to the upper part by means of the mounting bracket. The lock mechanism is preferably automated, where the lock mechanism automatically is unlocked by means of suitable driving means. The embodiment is preferably equal in both ends of the bed construction, and the lock mechanism in both ends is preferably unlocked at the same time. The embodiment can be compared with the first embodiment. The upper part includes preferably a transverse beam which connects to two ears with similar outer shape and circumference, which ears extend on each side of the transverse beam, which transverse beam will be a part of the frame construction of the bed, in the same way as the transverse beams in the first described embodiment. Between the ears is formed a through recess with preferably the same width as the transverse beam. The lower part includes a leg which centrally forms a curved shape with the same circumference as the ears and which has a width which is adapted to the width of the through recess, in which the curve is arranged/splined into. The leg has preferably the same function as the legs described in the first embodiment. The thick-walled tube with a mounting bracket, described above, is fixed by means of suitable means to the flat side of the ear which is facing in against the frame construction. A bar connected to a locking pin extends axially through the thick-walled tube. The thick-walled tube is as above enclosed by the tube axis and fixed to this as above. The ear which is facing in against the frame construction and the curve of the leg has similarly central holes/openings/recesses, which openings are exactly adapted to the locking pin, which preferably can be starred with three teeth. The ear which is facing away from the frame construction has a central circular opening with a diameter which is large enough that the locking pin without hindrance can be pushed out as the upper part is to be unlocked from the lower part. In unlocked position the locking pin will be pushed entirely out of the central opening in the ear facing inwards, but will still be inside the opening/recess in the curve. As the locking pin on the other hand fills the central openings/recesses, in the inwards facing ear and curve, respectively, the upper part will be locked to the lower part. The driving means, which can be an electromagnet, is arranged inside the tube axis. The bar is arranged as an axle of the locking pin, and lies inside and extends axially in the thick-walled tube. When unlocking, the driving means provide a pushing force to the bar. The locking pin, which is arranged to the bar, will thus be pushed out of locked position. In unlocked position, the upper part can be tilted about the rotation axis (the tube axis). Favourably return means, such as a spring, are arranged in the other end of the bar, which during unlocking will be pressed together and provide a stored force, which can be used to make sure that the locking pin with the bar is pushed back to the locked position at the same time as the upper part is tilted back into the horizontal position/initial position, and as the openings/recesses in the ear facing inwards and the curve of the leg, respectively, coincides with each other, and thus opens to allow the locking pin to slide into these.

By means of simple modifications, the automatic lock mechanisms in the embodiments above can be made manual, with or without the use of suitable mechanic constructions for transmission of power, such as wires, bars, pulleys, toothed wheels, hinges and/or springs.

It is also obvious that both the different embodiments can be combined, for example one embodiment can both include a lock mechanism arranged in the tube axis and lock mechanisms arranged at peripheral/external positions of the tube axis.

### EXAMPLE

The invention will be described in more detail below with references to the drawings, where

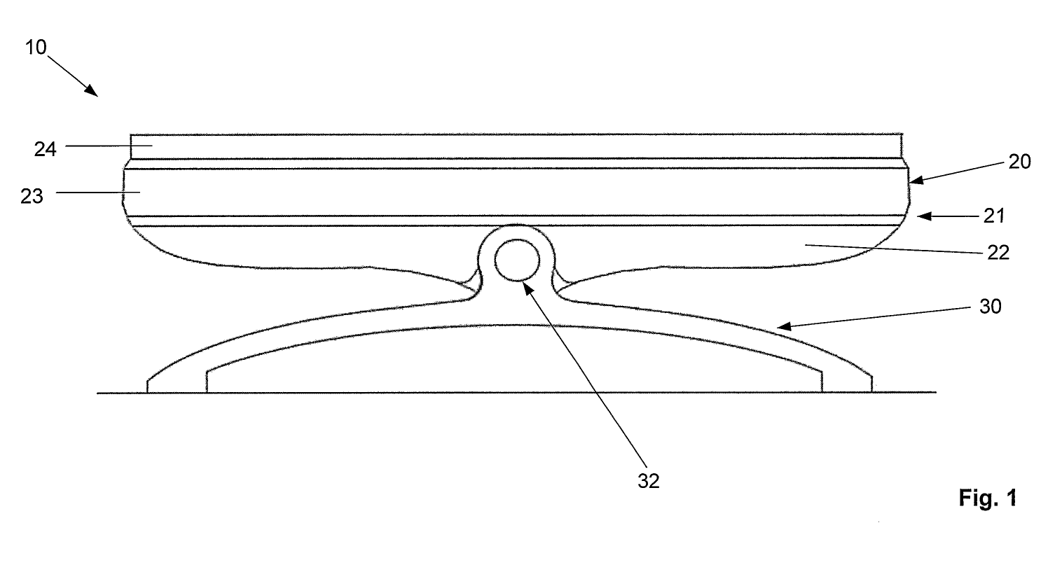

FIG. 1 is a cross section view of a first embodiment of the invention in the form of a bed, seen from the front,

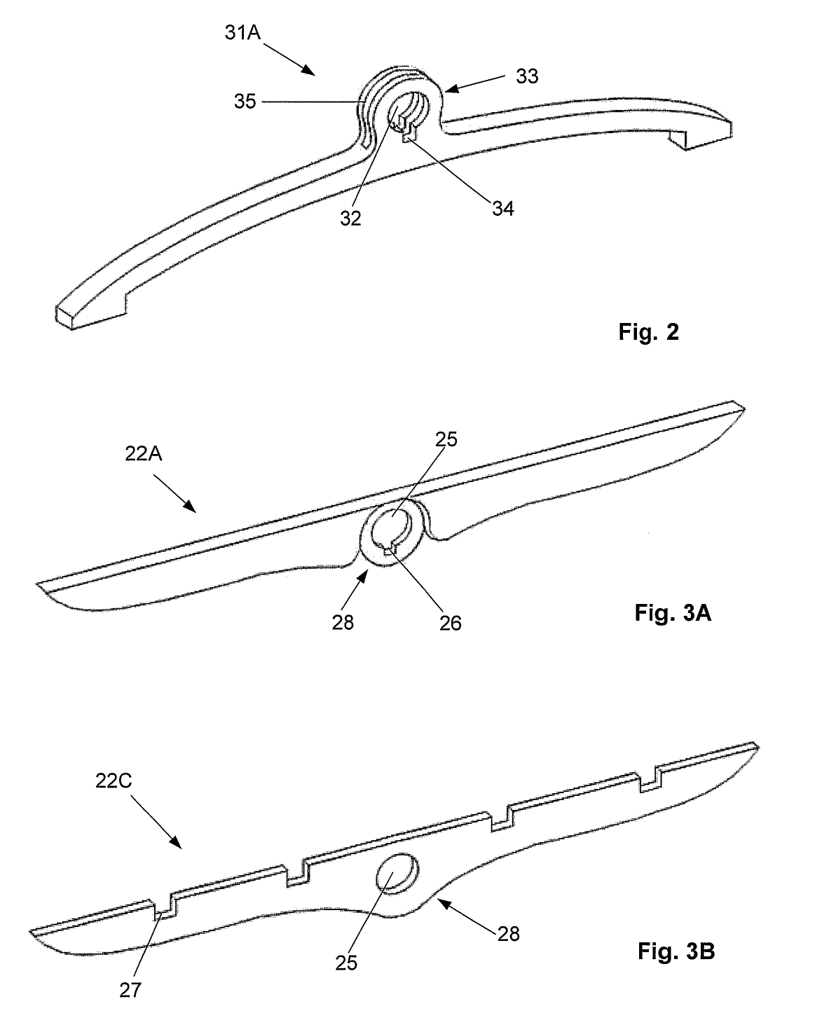

FIG. 2 shows details of a leg of the bed in FIG. 1,

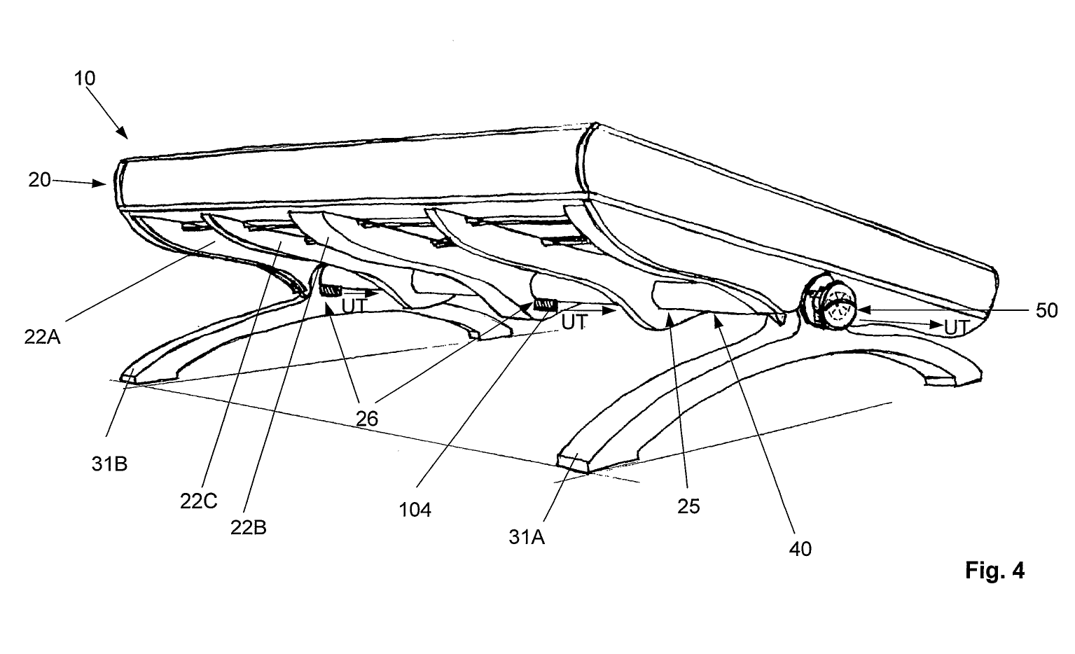

FIG. 3A shows details of transverse beam 22A for arrangement together with the leg in FIG. 2,

FIG. 3B shows details of another transverse beam 22C,

FIG. 4 shows an embodiment of an assembled bed, seen inclined from the underside,

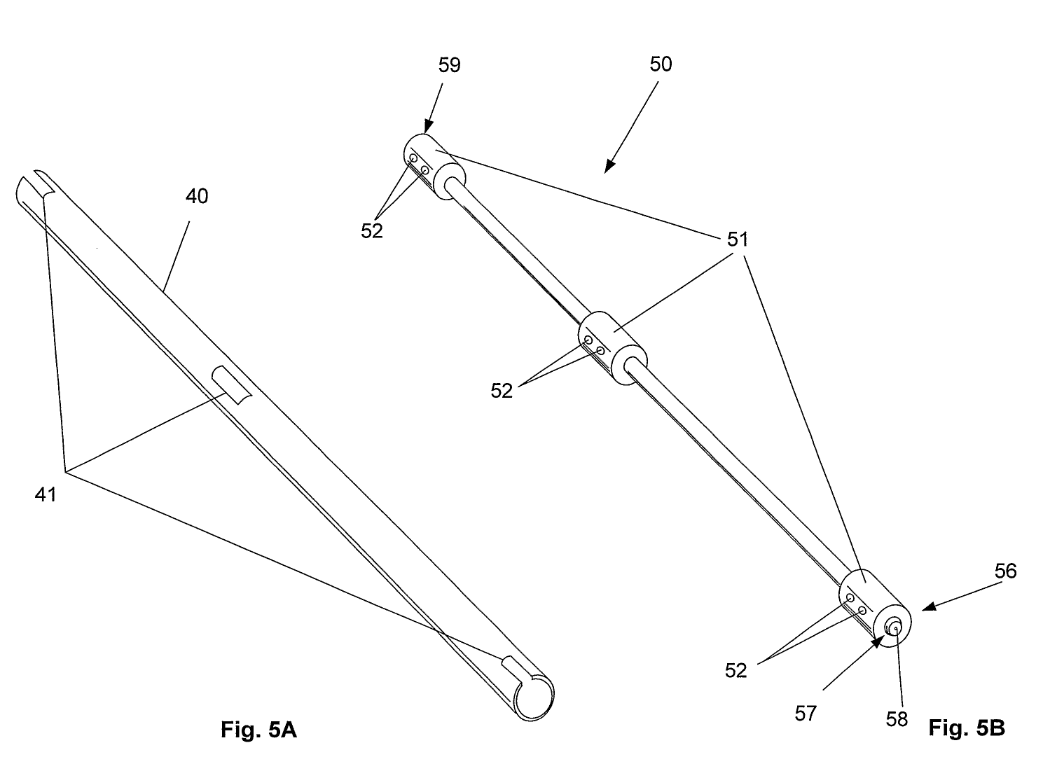

FIG. 5A shows an embodiment of a tube axis with longitudinal milled openings,

FIG. 5B shows an embodiment of an axle with sleeves for insertion in the tube axis in FIG. 5A,

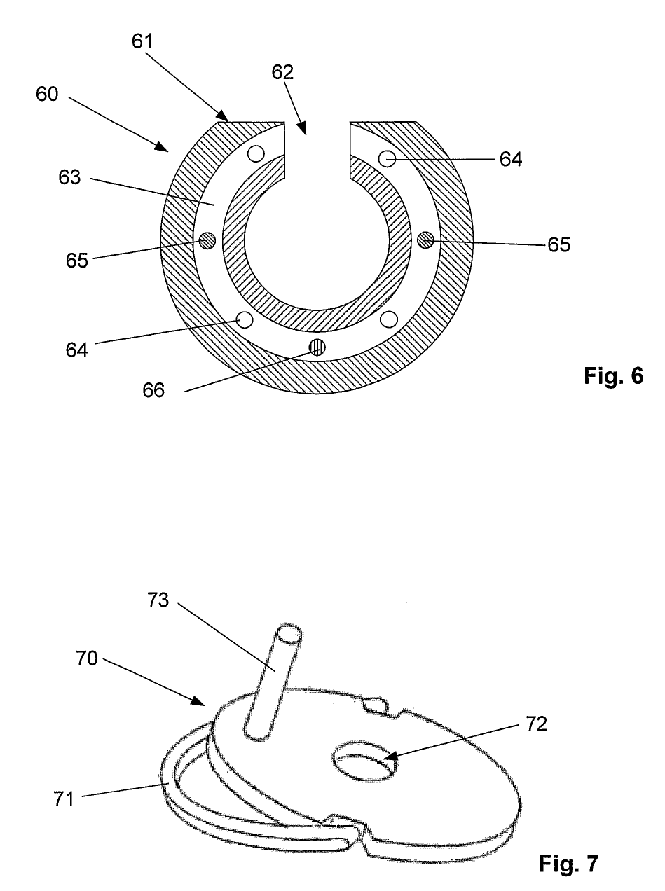

FIG. 6 shows an embodiment of a lock disc for the lock mechanism,

FIG. 7 shows an embodiment of a turnable disc with a handle for handling of the lock mechanism,

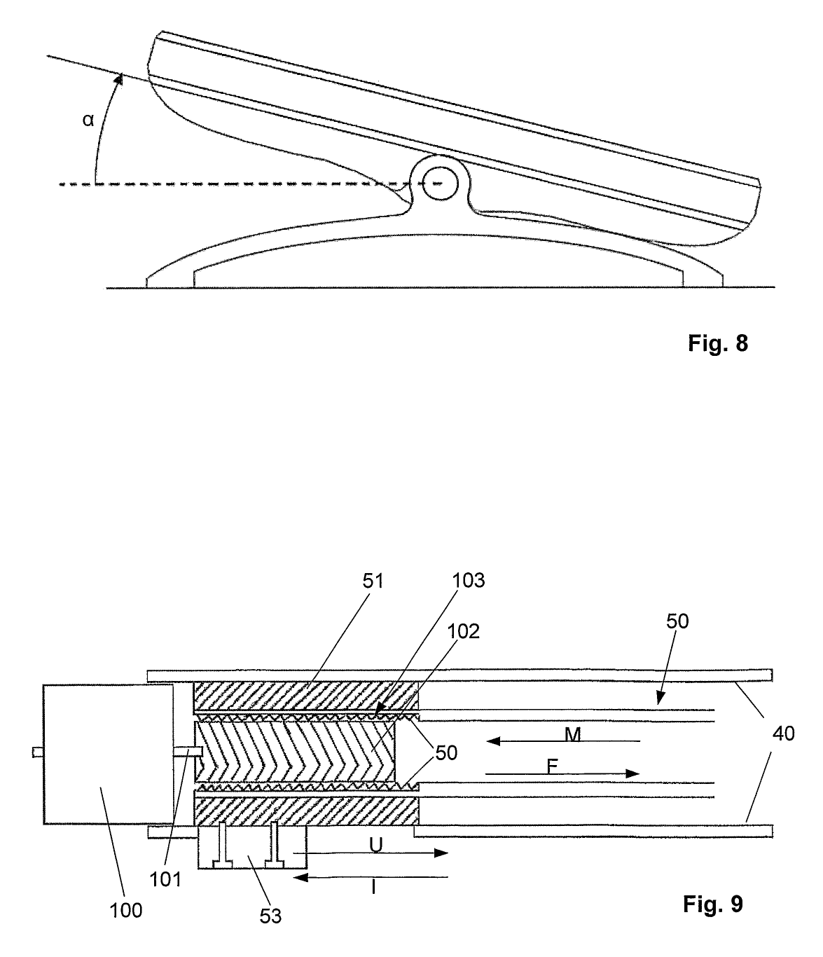

FIG. 8 shows the bed in FIG. 1, where the upper part is tilted an angle a in relation to a normal position,

FIG. 9 shows an embodiment of an automated lock mechanism,

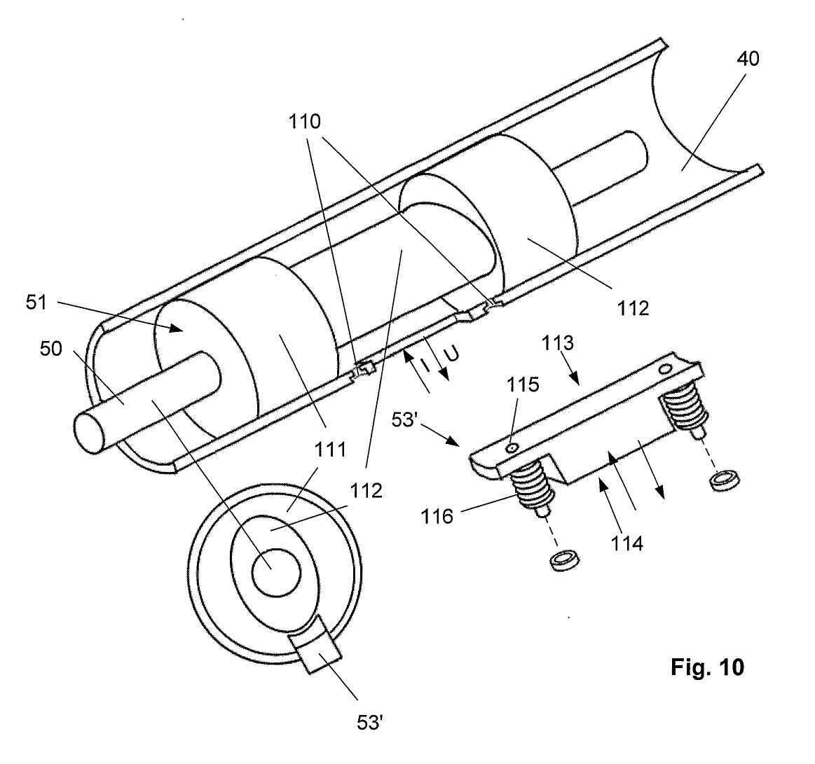

FIG. 10 shows a further alternative embodiment of a lock mechanism,

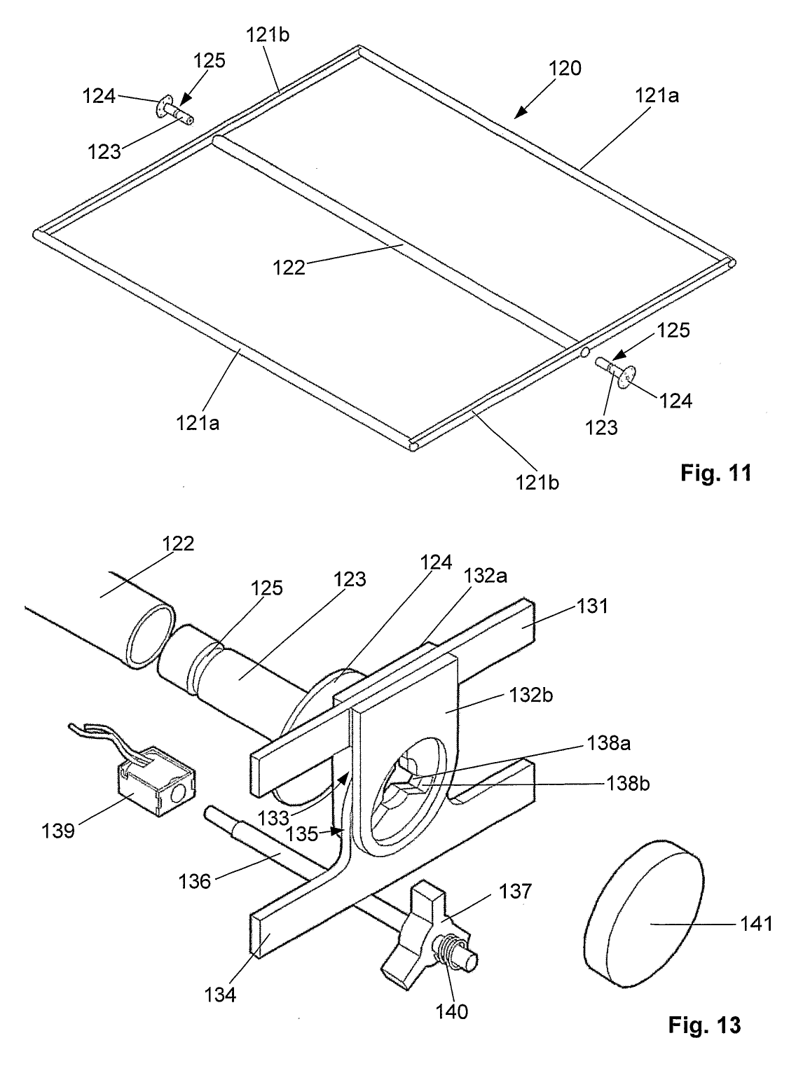

FIG. 11 shows a frame construction for a bed,

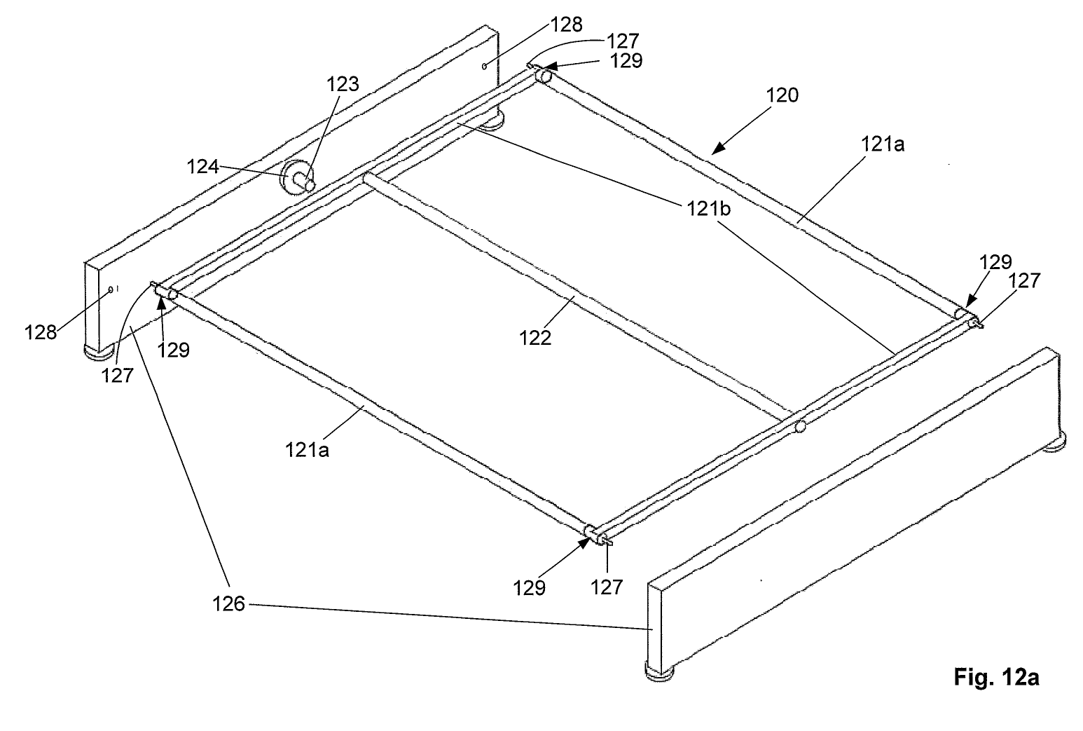

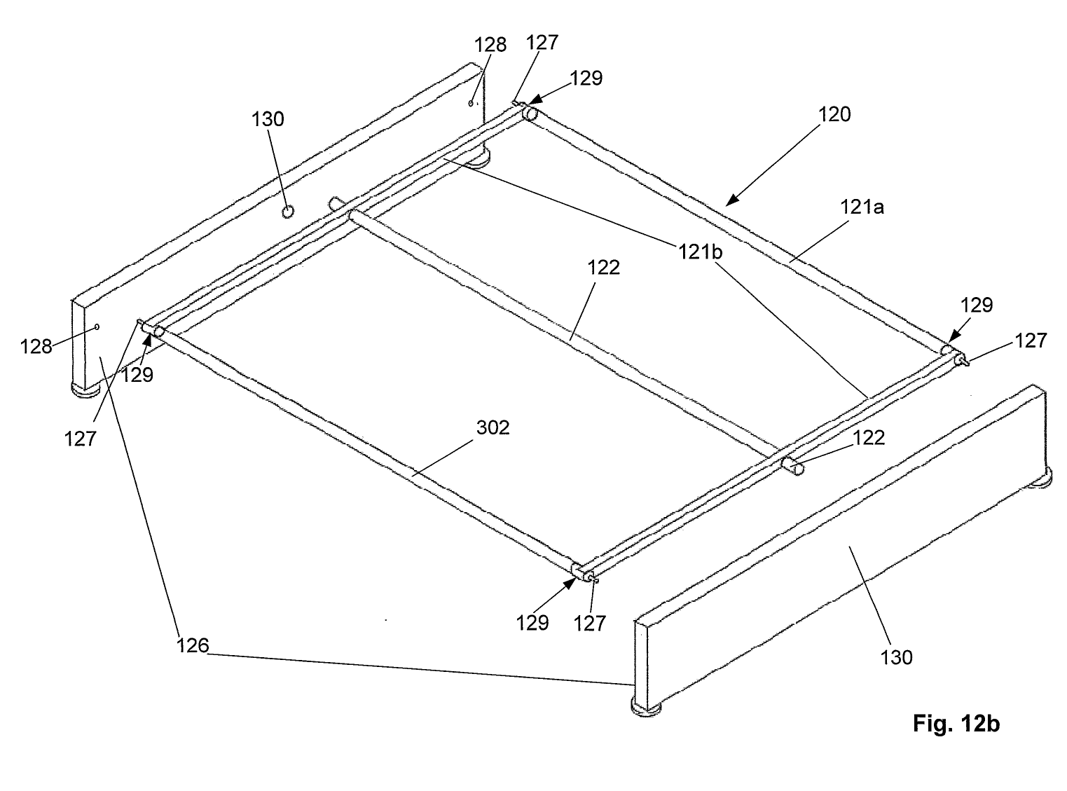

FIG. 12a is a principle drawing of an embodiment with a frame construction in FIG. 11,

FIG. 12b shows an alternative embodiment of the embodiment shown in FIG. 12a,

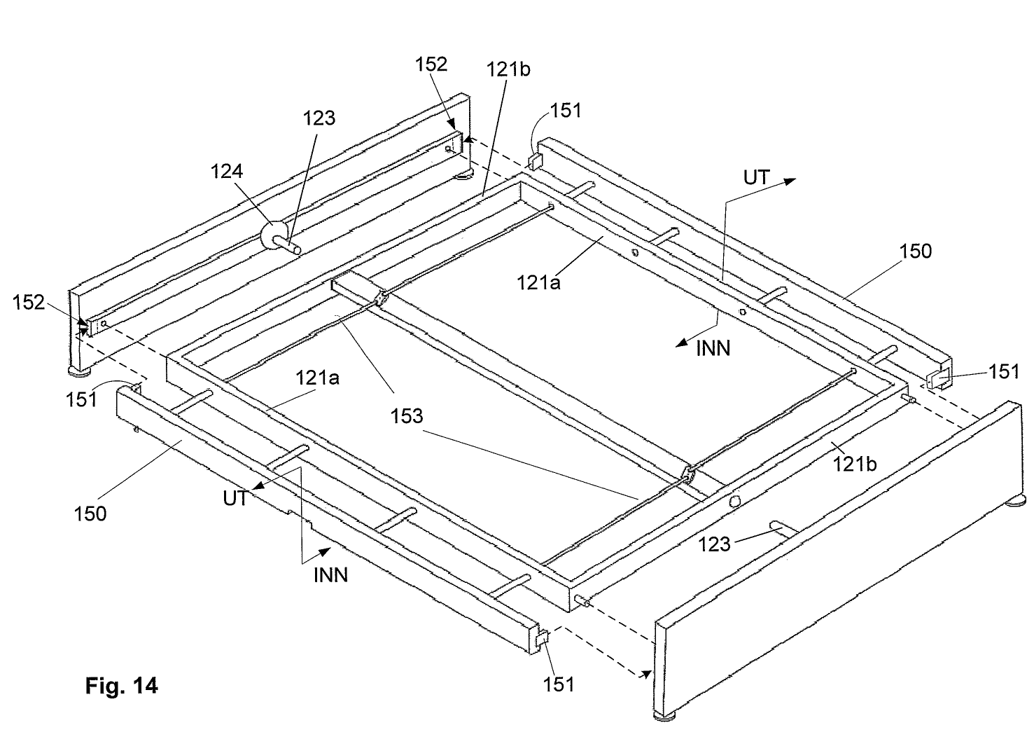

FIG. 13 shows an alternative lock mechanism, where the lock mechanism is arranged in the tube axis, and

FIG. 14 shows an enhanced lock mechanism of the embodiment shown in FIG. 12a and 12b.

FIG. 1 shows an embodiment of the invention in the form of a bed 10, seen from the front, which is provided with a tilt mechanism according to the invention with a manual lock mechanism. The bed includes an upper part 20 and a lower part 30. The upper part includes, for example, a bed bottom 21 with transverse beams 22 (on the figure hidden by a cover strip), bed sides 23 (shown in the figure with a bevel at the top), and mattress/bed base 24. The bed bottom 21 and the transverse beams 22 are fixed together by suitable fastening means, such as screws.

The lower part 30 includes preferably at least two legs 31A and 31B, (shown by means of the leg 31A in FIG. 2, see also FIG. 4), which has a centrally arranged hole 32 in the top of the curve. The legs 31A and 31B have preferably a curved profile which extends up from the floor with an additional curve around the hole 32. The hole 32 has in addition a rectangular recess 34 in the bottom of the hole 32, as shown in FIG. 2, which is adapted for locking means (described later).

Referring now to FIG. 2. The legs 31A and 31B have in the vertical direction a centrally arranged through recess 35, which extends through the curve 33, adapted for insertion of a corresponding curve of the transverse beams 22A, described below.

Referring now to FIGS. 3A and 3B which shows the transverse beams. The transverse beams 22A, 22B and 22C, (shown as 22A and 22C in FIGS. 3A and 3B, respectively), have a centrally arranged hole 25. The transverse beams 22A, 22B and 22C are evenly distributed over the bed bottom 21 and the length of the bed. The distance between and the number of transverse beams 22A, 22B and 22C depends on the length of the bed bottom 21 and accordingly the bed, and the number of legs 31A and 31B. The width of the transverse beams 22A, 22B and 22C will depend on the material they are made of, and the number of the different transverse beams, such that they have the necessary strength and elasticity.

In the example, the bed includes five transverse beams, two beams marked 22A, one beam marked 22B and two beams marked 22C, respectively, see FIG. 4. The transverse beams have a flat profile on the one side that is resting on the bed bottom 21, and via which profile they are fixed to the bed bottom 21. In this profile, only for 22B and 22C, see FIG. 3B, recesses 27 are arranged to receive longitudinal bottom parts of the bed bottom 21.

The lower parts of the transverse beams 22A-C preferably have a curved profile with an additional curve 28 around the centrally arranged hole 25. The curved shape is especially advantageous as regards obtaining maximum space under the bed.

The middle transverse beam 22B, which is arranged in the middle of the underside of the bed bottom, i.e. in the middle between the legs 31A and 31B, is preferably dimensioned to be stronger than the other transverse beams, as it will be exposed for greater strain. The transverse beam 22B has in addition a recess in the bottom of the hole 25, adapted for locking means (described later).

The transverse beams 22C are arranged in the middle between the middle transverse beam 22B and the transverse beams 22A.

The transverse beam 22A has a narrow area around the curve 28, such that the width of the curve is adapted for insertion in the recess 35 of the legs 31A and 31B, respectively.

Referring now to FIG. 4, which shows an example of an assembled bed 10, seen inclined from below, but without the mattress 24. The Figure shows how the different components are assembled together to one unit. The above described elements, i.e. the upper part 20 and the lower part 30 are arranged together by means of a tube axis 40, which extends from the leg 31A and through the transverse beams 22A, 22B and 22C and to the leg 31B, by means of the holes 25 and 32. The outer diameter of the tube axis 40 is adapted to the diameter of the holes 25 and 32, which holes advantageously have the same diameter.

Referring now to FIGS. 5A and 5B, which show a view of a tube axis 40 and an axle 50, respectively, according to the invention. The Figures are only illustrative and must not be regarded as correct with regard to mutual size. The tube axis 40 and axle 50 form the basics for the tilt/lock mechanism according to the invention.

The tube axis 40, which is shown in FIG. 5A, has in both ends and in the middle, preferably rectangular openings 41 which extend in the longitudinal direction of the tube axis 40. These rectangular openings 41 have a size which is adapted for insertion of locking means (described below), and which extends a distance in the longitudinal direction which is large enough that the locking means can be moved back and forth, between two extreme points, a function which is used in relation to pivoting/tiling of the bed (described later).

The tube axis 40 is arranged so that the openings 41 coincide with the rectangular recesses in the legs 31A and 31B and the transverse beams 22A and 22B, when the tube axis connects the upper part 20 and the lower part 30 together.

In the tube axis 40, a manual lock mechanism is arranged, which element is an axle 50 with sleeves 51, as shown in FIG. 5B. The sleeves 51 are also preferably tubular and are fixed to the axle by means of for example welding or fixed in another suitable manner. The outer diameter of the sleeves 51 is adapted to the inner diameter of the tube axis 40, while the outer diameter of the axle 50 is somewhat smaller than the diameter of the sleeves 51. This makes it possible for the axle 50 with sleeves 51 to rotate freely in the tube axis 40. The sleeves 51 extend over a distance in the longitudinal direction of the axle 50 and are arranged at both ends of the axle 50 and in the middle of the axis 50, respectively. In this way the sleeves 51 coincide with the openings 41 in the tube axis 40, as the axle 50 is arranged in the tube axis 40. The sleeves 51 preferably have a minor flat side, in which threaded holes 52 for fastening of locking means (described below) are arranged, the flat side being planar to provide as great contact surface as possible with the locking means which preferably have a rectangular form (described below).

After insertion of the axle 50 in the tube axis 40, where the holes 52 of the sleeves 51 are adapted to the rectangular openings 41 of the tube axis 40, locking means 53 can be arranged on the sleeves 51. The locking means 53 are preferably rectangular with a size which is adapted to fit into the rectangular openings in the tube axis 40 and the rectangular recesses 26 and 34. The locking means 53 are fixed to the sleeves 51 by means of for example screws 54 (shown in FIG. 9), or in another suitable way, by means of through holes in the locking means 53. The through holes are preferably adapted to the profile of the screws 54, such that the screws 54, when completely screwed in, are hidden in the locking means 53.

After the locking means 53 are fixed to the sleeves 51, the axle 50 is secured to be held in the correct position in the tube axis 40, and the upper part 20 is locked to the lower part 30 if the locking means 53 are inserted into the rectangular recesses 26 and 34 in the different elements of the upper part and the lower part.

At one of the ends 56 of the axle it is arranged a preferably circular rounded projection 57, with a centrally arranged threaded hole 58 for fastening of an outer fixing screw (described below).

At the other end 59 of the axle the sleeve 51 is recessed on the axle 50, such that the axle 50 forms a circular projection outside the sleeve 51. At the end 59 in addition a spring is arranged (not shown). A through pin (not shown) of suitable material is arranged in the transverse direction of the axle 50, for example screwed through two threaded holes (not shown) which are arranged in the wall of the axle 50, firmly welded or fixed in another way. The spring is provided at both ends with fastening means, in the form of preferably a hook, ring or similar, and attached to the pin extending transverse inside the axle 50 at one end. The other end of the spring is attached to an inner disc (not shown) via a hook arranged at the inner disc (not shown). The function of the spring is described below.

At the end 56 of the axle 50 a lock disc 60 is arranged, as shown in FIG. 6. The lock disc 60 has an outer diameter adapted to the curve 33 of the leg 31A, and accordingly also the narrow area around the curve 28 of the transverse beam 22A. The lock disc 60 has an inner diameter which is adapted to the outer diameter of the tube axis 40. The lock disc 60 is flattened at one side 61, which side has a slit 62, which is adapted to the longitudinal opening 41 at the end of the tube axis, and which slit 62 has a width which corresponds to the longitudinal opening 41 of the tube axis 40 and which is adapted to the locking means 53.

The lock disc 60 has further preferably a track 63, arranged between the circumference and the inner diameter of the lock disc 60. The track 63 has through holes 64 evenly distributed along the track 63 for fastening the disc 60 to the leg 31A, by means of for example screws (not shown). In the track two projecting stops 65 are also arranged which limit the rotating angle of the disc 70 (described later).

In the track 63 a through hole 66 is also arranged for a lock bolt 73 (described below), which hole is used by the lock bolt 73 to secure the bed in locked position.

A disc 70 with a handle 71, as shown in FIG. 7, is arranged rotatably outside the lock disc 60. The disc 70 has an outer diameter which corresponds to the outer diameter of the lock disc 60. The disc 70 has a centrally arranged hole 72 which has an inner diameter which is adapted to the profile of a lock nut (not shown). The inner diameter of the nut is adapted to fit on the outside of the projection 57 at the end 56 of the axle. The lock nut has an outer flange arranged at one end. The hole 72 has an inner flange which is adapted to the outer flange of the lock nut, such that a freely rotatable connection is provided between the lock disc 60, the disc 70 and the axle 50. The disc 70 includes in addition a firmly arranged lock bolt 73. The lock bolt 73 is arranged at the diameter of the disc 70, on the half of the disc not including the handle 71, and projects perpendicularly out from the disc 70. The lock bolt 73 is arranged at a distance from the perimeter of the disc 70, which distance is adapted to the track 63 of the lock disc 60 and accordingly the hole 66 of the lock disc 60.

The disc 70 is fixed to the axle 50 by means of the lock nut, described above, via a screw (not shown) which is inserted in the threaded hole 58 of the axle 50.

At the end 59 of the axle 50 an inner disc is arranged (not shown), which preferably has a centrally arranged hook (not shown) for fastening to the spring (not shown) which is arranged inside the axle 50. The hook can be fixed to the disc by means of welding or in another suitable way. The outer diameter of the inner disc is adapted to the narrow area around the curve 28 of the transverse beam 22A. The inner disc is fixed to the leg 31B by means of, for example, a screw via threaded holes in the disc. At the opposite end to that where the hook is arranged, the inner disc has a centrally threaded recess (not shown) for insertion of a threaded fixing screw (not shown). Outside the disc a cover disc is arranged (not shown), the diameter of which is somewhat larger than the diameter of the inner disc. The cover disc has a centrally arranged hole for insertion of a fixing screw (not shown) for fastening to the inner disc via its threaded recess.

The above described elements form a spring-loaded manual lock mechanism. A stable and locked position is provided when the locking means are in a position where they are inserted into the recesses 26 of the transverse supporting beams 22A and 22B of the upper part 20 of the bed, the recesses 34 of the legs 31A and 31B, and the slit 62 of the lock disc 60.

By pulling the handle 71 of the disc 70, in the direction of the arrow UT in FIG. 4, which is arranged at the foot end of the bed, i.e. at the end 56 of the axle, the axle 50 with its sleeves 51 and locking means 53 will be pulled out of locked position, to a position where the upper part 30 is not locked and make pivoting/tilting of the upper part 20 in relation to the lower part 30 possible. Pivoting/tilting can be performed both ways about the tube axis 40 with the axle 50. The maximum tilting position for the lock mechanism is reached when the lock bolt 73 makes contact with the stops 65. To provide a certain distance for the axle 50 when it is pulled out, and to make sure that it returns to locked position with a certain force of itself, the spring force is used from the built-in spring. As the upper part 20 is tilted to the side, as for example is shown in FIG. 8, a large free space under the bed is obtained, and for example cleaning can be performed. The angle and the line geometry of the legs, which centrally surround the tube axle, determine how large the pivoting/tilting angle α (FIG. 8) becomes, the larger the angle from the horizontal plane, the larger the distance from the floor to the bed bottom.

As the bed is to be returned to its normal position, the upper part is tilted back into horizontal position and the handle is used to rotate the disc 70 back to the initial position, where the lock bolt 73 is inserted into the hole 66 and the axle 50 with sleeves 51 and the locking means 53 are pulled back to a locked position by means of the spring force, as described above. The upper part 20 is thus secured and locked to the lower part 30.

It is also possible to provide automated propulsion and retraction of the axle 50, instead of manual pulling and spring-based retraction. An example of such a solution is shown in FIG. 9. Instead of manual pulling and spring force retraction of the axle 50 extending through the tube axis 40, an automated lock mechanism is used, for example an electric motor 100 to push and retract the axle 50. The electric motor 100 is then advantageously arranged partly or entirely inside the tube axis 40 (for example at the head end of the bed, i.e. at the leg 31B and the end 59 (FIG. 5B) of the axle), and has an axle 101 connected to a threaded bolt/screw 102. The spring inside the axle 50 is in this example replaced with a thread on the inner wall 103 of the axle 50. The threaded bolt 102 has a profile and a size that is adapted to the threads 103 at the inner wall of the axle 50. The threaded bolt 102, which is connected to the motor axle 101, will be able to screw the entire axle 50 away from or towards the bolt 102, depending on the rotation direction of the electric motor 100. As the axle 50 is screwed in a direction by the electric motor 100, as shown by arrow F, the locking means 52 are pushed out of the recesses 26 and 34, shown with arrow U and thus make the upper part 20 tiltable in relation to the lower part 30. As the motor 100 rotates in the opposite direction, the rotation in the threaded bolt will ensure that the axle 50 retracts again, shown by arrow M, and the locking means 53 are accordingly retracted into the recesses 26 and 34, as shown by arrow I.

Various security devices may be used, so that it is not possible to run the electric motor without certain criteria being fulfilled, for example such that the electric motor can not be run if the upper part of the bed is not in a horizontal position, i.e. a position where the locking means 53 can be guided into the recess 26 and 34 and the slit 62.

A further embodiment is shown in FIG. 10. The figure shows a cut away view of the tube axis 40, where the axle 50 with sleeves 51 is arranged. In addition two holes 110 are arranged at each side of the recesses 41 of the tube axis 40, which holes 110 are arranged for fastening of locking means 53′, described above. The sleeves 51 have here two circular end areas 111 and a middle area 112 which has an elliptical shape and which has a smaller circumference than the end areas 111. The width of the middle area is adapted to the length of the locking means 53′, described below. The locking means 53′ is here designed with a curved rectangular base 113 with a centered rectangular projection 114, which projection 114 corresponds to the locking means 53 in the previous examples. Through holes 115 arranged at each end of the base 113 for insertion of a screw for fastening of a spring 116. To the locking means 53′ two coil springs 116, or similar, are mounted to provide the locking means 53′ a springy effect. The locking means 53′ is fixed to the tube axis 40 by means of nuts after the screws are inserted through the holes 110 of the tube axis 40.

This embodiment works in the following way, as the axle 50 with sleeves 51 rotates by means of, for example, an electric motor (not shown), the elliptical middle area 112 of the sleeves 51 will result in the locking means 53′ being pressed down through the openings 41 of the tube axis due to the spring 116 forces, and the upper part 20 is unlocked for pivoting/tilting. As the rotation of the axle 50 is performed the opposite way, the elliptic shape of the middle area 112 of the sleeve 51 will push the locking means 53′ out through the openings 41 of the tube axis and to a locked position, so that the upper part 20 is locked to the lower part 30. The advantage of such a solution is that no movement of the axis 50 in the longitudinal direction is necessary.

With the two last mentioned solutions, the disc 70 with handle 71 or lock bolt 73 is not needed, as the disc will only have an aesthetic function, as will be to hide the axle 50 with sleeves 51 and locking means 53′. The lock disc 60 is also not needed, but a cover disc can be arranged at the end 56 of the axle 50.

Manual means for rotating the axle 50 can also be provided by means of plain modifications, as described earlier.

For beds with, for example, bed bases, or similar it, can be suitable with a frame construction. An example of such a frame construction is shown in FIG. 11. A frame construction 120 according to the invention preferably includes at least two longitudinal frame elements 121a and at least two transverse frame elements 121b, which together form a preferably rectangular frame. To the frame construction is further arranged a tube axis 122 in a suitable way, which tube axis 122 preferably is arranged centrally/in the middle of the frame construction 120, and extends in the longitudinal direction of the frame construction.

In one embodiment it further includes a thick-walled tube 123 with a mounting bracket 124 at the one end. The mounting bracket 124 is, for example, provided with holes for fastening to a headboard/footboard 126 (FIG. 12a) or the upper part 20 or lower part 30 of a bed, by means of, for example screws. The thick-walled tube 123 has an outer diameter which is adapted to the inner diameter of the tube axis 122, such that it can be inserted into the tube axis 122 and fixed in a suitable manner, for example, by means of a screw (not shown) extending through a hole (not shown) of the tube axis 123. If the mounting bracket 124 is fixed directly to the headboard/footboard 126 of the bed, as shown in FIG. 12a, it will be advantageous to use peripheral lock mechanisms (shown in FIG. 12a and 12b), i.e. peripheral in relation to the tube axis 122. A peripheral lock mechanism can be provided by arranging means for locking in the longitudinal frame elements 121a, in each of end of the longitudinal frame elements 121a, for example, in the form of lock pins 127. The bed headboard and footboard 126 are further provided with lock holes 128, adapted to the lock pins 127. The lock pins 127 can be pushed in and retracted out of these lock holes 128, for example, by means of electric propulsion means 129, such as electromagnets, which propulsion means 129 preferably are arranged in the longitudinal frame elements 121a. In this way, the upper part, i.e. the frame construction 120, can be unlocked and locked in relation to the lower part, i.e. the headboard/footboard 126.

By use of a peripheral lock mechanism as described above it is not necessary to use the thick-walled tube 123 with mounting bracket 124, but the tube axis can instead extend somewhat further than the frame construction 120 in the longitudinal direction and into adapted holes 130, arranged for this purpose in the headboard and footboard 126, such that a rotation point for the tube axis 122 and the frame construction 120 is provided in the holes 130, as shown in FIG. 12b.

In another embodiment, as shown in FIG. 13, the tube axis 122 and the thick-walled tube 123 with mounting bracket 124 are used to provide an alternative lock mechanism, where the lock mechanism is arranged in relation to the thick-walled tube 123, where the thick-walled tube 123 (and the tube axis 122) is fixed to the upper part 20 by means of the mounting bracket 124. The lock mechanism, which will be described below, is preferably automatic, where the lock mechanism is unlocked by means of, for example, propulsion means, such as electromagnets. The embodiment is preferably similar at both ends of the bed construction, and the lock mechanisms at both ends, are unlocked at the same time. The embodiment will now be described with regards to FIG. 13, which shows an enlarged view of the area around the lock mechanism, seen in relation to one of the ends of the bed, at the foot end or head end.

The embodiment can be compared with the first embodiment, described above, as shown in FIG. 4. The embodiment will now be described in relation to the one end, either foot end or head end.

The upper part in this embodiment includes preferably a transverse beam 131, provided with two ears 132a and 132b, which transverse beam 131 will be a part of the frame construction of the bed, in the same way as the transverse beam 22A, as described in the first embodiment. The ears 132a and 132b have similar outer shape and circumference, which ears extend on each side of the beam 131. Between the ears 132a and 132b, a through recess 133 is formed. The lower part 30 includes in this embodiment a leg 134 which centrally forms a curved shape 135, with preferably the same circumference as the ears 132a and 132b, and which has the same function as the legs 31A and 31B in the first embodiment. The curve 135 has a width which is adapted to the width of the through recess 133, and the curve 135 is arranged/splined into the recess 133. The thick-walled tube 123 with mounting bracket 124 at one end, described above, is fixed by means of suitable means, such as screws, to the flat side of the ear 132a. A bar 136 is connected to a lock pin 137, and extends axially through the thick-walled tube 123. The thick-walled tube 123 is as mentioned above, surrounded by the tube axis 122 and fixed thereto as described above. The ear 132a and the legs curve 135 have centrally similar holes/openings/recesses, 138a and 138b, respectively, and the shape of these openings 138a and 138b is exactly adapted to the lock pin 137, which preferably is starred with three teeth. The ear 132b has a central circular opening with a diameter which is large enough that the lock pin 137 without hindrance can be pushed out as the upper part 20 is unlocked from the lower part, i.e. the leg 134. In unlocked position, the lock pin 137 will be pushed entirely out of the central opening 138a of the ear 132a, but will still be inside the opening/recess 138b in the curve 135. As the lock pin 137 on the other hand fills the central openings/recesses 138a and 138b, of the ear 132a and curve 135, respectively, the upper part will be locked to the leg 134.

The driving source 139, such as for example an electromagnet is preferably arranged inside the tube axis 122. The bar 136 is arranged as a shaft to the lock pin 137, and is situated inside and extends axially in the thick-walled tube 123. At unlocking, the driving source 139 provides a pushing force on the bar 136. The lock pin 137 will thus be pushed out of locked position. In unlocked position, the upper part 20 can be tilted about the rotation axis. Further, advantageously return means 140 are arranged, such as a spring in the other end of the bar 136, which during unlocking will be pressed together between the lock pin 137 and a cover disc 141, which cover disc 141 preferably is fixed to the ear 132b. The stored spring force will ensure that the lock pin 137 with the bar 136 is returned to lock position at the same time as the upper part 20 is tilted back to horizontal position/initial position, and as the openings/recesses 138a and 138b of the ear 132a and the curve 135, respectively, coincide with each other, and thus allow the lock pin 137 to slide into these.

It is noted that the lock pin and thus the reciprocal openings/recesses of ear (132a) and curve (135) can be varied in shape and size. For example the lock pin can have fewer or more teeth, and the description above must be understood as only one alternative of the many design possibilities that a lock pin can have.

A construction as described above and as shown in FIGS. 12a and 12b, can advantageously be stiffened with different kinds of stabilising devices. FIG. 14 shows an example of such a device, consisting of extractable stiffening elements in the form of bed sides 150. The bed sides 150 are arranged on longitudinal frame elements 121a, and the bed sides 150 are in addition provided with suitable fastening means 151, which lock to connection elements 152 of the headboard and footboard 126. The bed sides 150 will in locked position thus support the construction consisting of the bed frame/upper part 120 and the headboard and footboard 126. Unlocking of the bed to obtain tilting properties of the upper part 120 about the rotation axis, is initiated extracting one of the bed sides 150 from the longitudinal frame elements 121a, and out of the connection elements 152 of the headboard and footboard 126. The bed sides 150 can besides, in a suitable way, be arranged to the lock mechanism for the lock pins 127 of the longitudinal frame elements 121a, so that the lock pins 127 unlock the upper part 120 from the headboard and footboard 126 as the bed sides 150 are extracted. To be able to perform extracting of both bed sides 150 at the same time, as the operator performs this from one of the longitudinal sides of the bed, the bed construction is preferably arranged with suitable mechanical constructions for transmission of power 153, provided with a power turning property.

This is only one example out of many examples of different modifications which can be made to provide support/stability to peripheral lock mechanisms.

### Modifications

Driving sources for automatic handling of the lock mechanism of the described embodiments can be different suitable means, such as electromagnets, electric motors, pneumatic and/or hydraulic systems.

The automatic lock mechanisms can by simple modifications be made manually operated with or without the use of suitable mechanical constructions for transmission of power, such as wires, bars, toothed wheels, hinges and/or springs.

A tilt damping mechanism (shock absorber(s) or similar) can be arranged to prevent that the upper part from being tilted with hard movements about the rotation axis, and thus ensures a smooth/soft tilting movement. This device can be fixed to the lower part of the furniture/bed, including the legs and/or one or more places of the tube axis, and to fastening points on optimal places of the underside of the upper part, including the bed bottom, transverse beams and similar.

As the design of the bed can be varied a lot, also the different elements, for example, the transverse beams and legs can have different profiles and sizes in relation to what is shown in the examples, and for example, the legs can have a straight profile instead of a curved profile.

Relief legs can also, if needed, be arranged under the bed bottom at suitable places to ease the pressure, for example, if the upper part of the bed needs to handle heavy loads. These legs must then be able to be retracted, or in some other way be deactivated before tilting of the bed's upper part can be performed.

Stabilising devices of the legs/lower parts, for example, in the shape of a bar that extends in the longitudinal direction of one leg to the other, can be arranged if required.

Principally all automatic and manual variants of the lock and tilt mechanism can be adapted to different kinds of furniture.

Simple modifications can be made such that the lock and tilt mechanism can be used for table constructions, when the purpose is to tilt the table top/the upper part of the table to a position which is adapted to the person operating at the table. The mechanism also makes it possible to tilt the table top about the rotation axis to provide more space in the room as the table is not used, for storing or at transport. In addition the mechanism will make it possible to ease the access to the floor area under the table.

Similarly, the lock and tilt mechanism can be adapted for use on a sofa, where, for example, the seat part can be made adjustable with regards to seat angle in relation to the floor plane. The seat part/upper part of the sofa is so tilted about the longitudinal rotation axis, arranged under the seat. The access to the floor area is thus easier, and the seat part can be turned and locked in a seat angle adapted to the user's wishes.

The lock and tilt mechanism can be modified for use on chairs, benches and similar which either are stationary or mobile (mobile meaning devices with wheels, or devices which not are fastened to the floor, wall or roof), such that it allows to that seat and/or back to be tilted and locked in a desired position, or that the tilting movement about the rotation axis makes it possible to collapse the seat, in this way to provide more space in the room or limit the need for space for storage, or to provide easier access to the floor area under the seat.

An embodiment can also be contemplated where the upper part of the furniture can be tilted and locked by providing the tube axis with several recesses, arranged in the circumference of the tube axis, and without the use of an axle. The tilting movement can then be unlocked by pulling the locking means, which are arranged with an activation mechanism, out of the recesses. As the upper part of the construction is tilted about the tube axis to a desired angle in relation to the lower part of the construction, the locking means are returned into the recesses in the tube axis which corresponds to the angle. The upper part is accordingly locked at a desired angle.

In addition it can be contemplated that different elements can be arranged in the one and same part. This will depend upon the choice of material for the separate parts. As an example the lock disc could be integrated into the leg, such that the leg and lock disc constitute the one and same piece, for example of aluminium.

In the end it should be noted that the one and same furniture/furniture device with a lock mechanism according to claim 1, can be provided with a combination of lock mechanisms, arranged both in and at peripheral/external places of the centrally/middle arranged tube axis.

What is claimed is:

1. Device for furniture, preferably to provide better access to the area under the furniture, for example in relation to cleaning, which furniture includes an upper part (20, 120, 131) and a lower part (30, 126, 134), wherein the upper part (20, 120, 131) can be tilted about a longitudinal rotation axis, between a substantially horizontal position and a vertical position, characterized in that the device includes a preferably centrally/middle arranged tube axis (40, 122) which directly or indirectly connects the upper part (20) to the lower part (30), and in which tube axis (40) and/or at suitable peripheral places of the tube axis (40, 122), a manual and/or automatic lock mechanism is arranged.

2. Device according to claim 1, characterized in that the tube axis (40) has preferably rectangular openings (41) which extend in the longitudinal direction of the tube axis (40), which openings (41) preferably are arranged at the ends of the tube axis (40) and in the middle of the tube axis (40).

3. Device according to claim 1, characterized in that an axle (50) extends through the entire tube axis (40), and that the axle (50) includes sleeves (51) arranged to fit with the openings (41) of the tube axis (40), which sleeves (51) preferably are tubular and preferably have an outer diameter which is adapted to the inner diameter of the tube axis (40), and that the axle (50) is provided with a preferably circular rounded projection (57) at the end (56) of the axle (57), in which projection is arranged a central threaded hole (58).

4. Device according to claim 3, characterized in that the sleeves (51) preferably include a minor planar side, at which planar side is arranged threaded holes (52) for fastening of preferably rectangular locking means (53) by means of suitable fastening means, which locking means (53) lock the axle (50) in the vertical direction of the tube axis (40), and that the sleeves (51) at the end (59) of the axle are spaced from the end of the axle (50), such that the axle (50) forms a projection out from the sleeve (51) in the longitudinal direction of the axle (50).

5. Device according to claim 1, characterized in that the lower part (30) includes two legs (31 A and 31B), which legs preferably have a curved profile with an additional curve (33) around a centrally arranged hole (32), which hole (32) preferably has a diameter which is adapted to the outer diameter of the tube axis (40), and via which hole (32) the tube axis (40), at insertion, connects the lower part (30) to the upper part (20), that in the bottom of the hole (32) is arranged a preferably rectangular recess (34) adapted for the rectangular locking means (53), and that the legs (31 A and 31B) preferably have a recess (35) which extends through the curve (33) and the hole (32).

6. Device according to claim 1, characterized in that the upper part (20) includes three different types of transverse beams (22A, 22B and 22C), which preferably are evenly distributed over the upper part (20), which transverse beams preferably have a curved profile with a centrally arranged hole (25).

7. Device according to claim 6, characterized in that the transverse beams (22A) have a narrow area around the hole (25) adapted to the recess (35) of the legs (31 A and 31 B) for insertion in the recess (35), and that in the bottom of the hole (25) of the transverse beams (22A and 22B) is arranged a recess (26) adapted for the rectangular locking means (53).

8. Device according to claim 1, characterized in that the manual lock mechanism further includes a lock disc (60), where the circumference of the disc (60) is adapted to the curve (33) of the leg (31 A), where the inner diameter of the disc (60) is adapted to the circumference of the tube axis (40), which disc (60) has a flattened side (61), in which a rectangular slit (62) is centrally arranged which extends from the flattened side (61) to the inner diameter of the disc (60), and which disc (60) includes a track (63), arranged between the circumference and the inner diameter of the disc (60), in which through holes (64) for fastening the lock disc (60) to the curve (33) of the leg (31A) by means of suitable means, such as fastening screws, and that on the central axis of the disc (60) is arranged a through hole (66) in the track (63), at the opposite end of the flattened side (61) of the disc, for insertion of a lock bolt (73).

9. Device according to claim 8, characterized in that the manual lock mechanism further includes a rotatable disc (70), provided with a handle (71), where the circumference of the disc (70) is adapted to the circumference of the lock disc (60), which disc (70) includes a centrally arranged through hole (72), which hole (72) includes a lock bolt (73) which is firmly arranged perpendicular to the disc (70), at a distance from the circumference of the disc (70) which is adapted to the track (63) and the hole (66), which disc (70) is arranged rotatably in relation to the axle (50) and the lock disc (60) by means of a lock nut which is adapted to the projection (57) of the axle, by means of a fastening bolt arranged in the threaded hole (58).

10. Device according to claim 8, characterized in that the manual lock mechanism further includes a spring arranged inside the end (59) of the axle, which spring extends in the longitudinal direction of the axle (50), which spring is fixed to the axle by means of suitable means, which spring in addition is fixed by means of suitable means to the end of the tube axis (40).

11. Device according to claim 1, characterized in that the upper part (20) includes a supporting frame construction (120), consisting of two or more longitudinal frame elements (121a), and two or more transverse frame elements (121b), and to which frame construction (120) a tube axis (122) is arranged, preferably centrally/middle.

12. Device according to claim 11, characterized in that the frame construction (120) is rotatably arranged to the lower part (126), either directly in such a way that the tube axis (122) is inserted into a hole (130) of the lower part (126) and connected in a suitable way, or indirectly such that the tube axis (122) is connected to a thick-walled tube (123) which is fixed to the lower part (126) by means of suitable means, such as fastening screws, and in that the lock pin (127) is arranged to/in the frame construction (120), peripheral to the tube axis (122), is inserted into lock holes (128) in the lower part (126).

13. Device according to claim 12, characterized in that the lock pins (127) lock and unlock the frame construction (120) to the lower part (126), either automatically by arranging driving source(s) (129), such as electromagnets, electric motors, pneumatic or hydraulic systems, to/in the frame construction (120), or with a manual driven release device, with or without the use of suitable mechanical constructions for transmission of power, such as wires, bars, pulleys, toothed wheels, hinges and/or springs.

14. Device according to claim 1, characterized in that the upper part (20) includes a transverse beam (131), arranged with two ears (132a) and (132b), which transverse beam (131) forms a part of the frame construction of the bed, which ears (132a) and (132b) preferably have a similar outer shape and circumference, which ears extend on each side of the beam (131), between which ears (132a) and (132b) is formed a through recess (133), which recess preferably has the same width as the transverse beam (131).

15. Device according to claim 14, characterized in that the lower part (30) includes a leg (134) which centrally forms a curve (135), with preferably the same circumference as the ears (132a) and (132b), which curve (135) has a width which is adapted to the width of the through recess (133), and which curve (135) is arranged/splined into the recess (133).

16. Device according to claim 15, characterized in that the upper part (20, 131) is arranged rotatably to a tube axis (122), via a thick-walled tube (123) with a mounting bracket (124) at one end, and fixed by means of suitable means, such as screws, to the flat side of the ear (132a), which thick-walled tube (123) is surrounded by the tube axis (122) and fixed by means of suitable means.

17. Device according to claim 16, characterized in that a bar (136) is connected to a lock pin (137), which extends axially through the thick-walled tube (123).

18. Device according to claim 16, characterized in that the ear (132a) and the curve (135) of the leg, centrally include similar holes/openings/recesses (138a) and (138b), respectively, and where the shape of these openings (138a) and (138b) is exactly adapted to the lock pin (137), which preferably is starred with three teeth.

19. Device according to claim 17, characterized in that the ear (132b) centrally includes a circular opening with a diameter which is larger than the lock pin (137).

20. Device according to claim 14, characterized in that the device further includes a driving source (139), such as an electromagnet, preferably arranged inside the tube axis (122), which driving source (139) is connected to the bar (136) and thus the lock pin (137).

21. Device according to claim 15, characterized in that the device further includes return means (140), such as a spring, at the other end of the bar (136), which return means (140) utilizes stored force to return the bar (136) and the lock pin (137).
